(19) United States
(12) Patent Application Publication
(10) Pub. No.: US 2004/0041033 A1
(43) Pub. Date: Mar. 4, 2004

(54) Electromechanically actuated pressure balancing and/or thermostatic valve system

(76) Inventor: William Harry Kemp, Clayton (CA)

Correspondence Address: Sequence Controls Inc., 150 Rosamond Street, Carleton Place, ON, K7C 1V2, CA

(21) Appl. No.: 10/232,367

(22) Filed: Sep. 3, 2002

(51) Int. Cl. G05D 23/13; G05D 15/00

(52) U.S. Cl. 236/12.12; 236/78 C

(57) ABSTRACT

An electromechanically actuated pressure balancing and/or thermostatic valve system, operable in a wet, electrically hazardous environment, used to control the temperature and flow of water supplying plumbing fixtures such as showers, baths and medical podiatry systems. The pressure and/or temperature balancing valve comprising a hot and cold water inlet and one or more mixed water outlets, includes a gear motor drivingly coupled to said pressure and/or temperature balancing valve. The switching device coupled to the motor, the switching device being operative in either a first state wherein significant current flow the motor is prevented or a second state wherein current flow through the motor causes rotation in a first direction or a third state wherein current flow through the motor causes rotation in a direction opposite to the first direction. The user controls provide desired mixed outlet water temperature setpoint. The controller comprising electronics for electrically operating the gear motor having one or more temperature sensors in thermal communication with the discharge water of said pressure and/or temperature balancing valve. The controller is adapted to be coupled to an AC source for supplying an AC signal. The isolation means electrically isolates the controller means from the AC source and includes electrical separation between the controller means and the AC source. Includes a rechargeable battery to provide operation during AC source failure.

### FIELD OF THE INVENTION

The present invention relates to devices used to control the temperature of water supplying showers, baths, podiatry baths and other plumbing systems. More particularly, the present invention relates to a pressure and/or temperature balancing valve comprising a hot and cold water inlet and one or more mixed water outlets, including a gear motor adapted to be coupled to said pressure and/or temperature balancing valve. It includes a controller comprising electronics for electrically operating the gear motor having one or more temperature sensors in thermal communication with the discharge water of said pressure and/or temperature balancing valve. The present invention also includes a rechargeable battery to provide operation during power failure.

### BACKGROUND OF THE INVENTION

Manually operated, pressure and thermostatic balancing valves are common in every day life. These valve systems are often installed in bath and shower areas, to regulate the flow of bathing water and to ensure precise water temperature in varying supply water conditions. A typical example of such an application is where the shower water temperature varies due to another water appliance being operated. A sudden drain on the cold water supply may drop the cold water pressure, while leaving the hot water pressure relatively constant, thus increasing outlet water temperature due to an imbalance between hot and cold inlet water flow.

Valves may be constructed to contain either pressure or temperature balancing modules or both. The present invention relates to valves of these types of construction, including an electrical operator means as will be presently described.

Traditionally, pressure or temperature balancing functions are controlled by mechanical means contained within the valve casing. The user operates the valve by opening rotating the valve stem and adjusting the water temperature to the desired setting. Once the user has selected the desired temperature setpoint by feeling the water outlet temperature, sudden changes in water inlet pressure or temperature will not seriously affect the outlet mixed temperature.

A pressure balancing module installed within the water control valve can rapidly adjust to varying pressure conditions, ensuring water outlet temperature remains essentially constant. Likewise, a thermostatic module installed in the similar valve can adjust to varying inlet water temperature changes, ensuring water outlet temperatures remain constant.

A person skilled in the art will recognise that water pressure variations tend to require high speed correction, due to the velocity of pressure waves within the conducting fluid. Short term lowering of one inlet water pressure can therefore be corrected by an essentially, simultaneous and equal pressure reduction at the other water inlet, without regard to mixed, outlet temperature. Provided both inlet water temperatures remain essentially constant, the outlet temperature will remain static as both inlet water pressures are modulated, during the pressure imbalance period.

Mechanical temperature balancing valves utilise an internal cartridge which is in fluid communication with the mixed, outlet water. A sudden change in water temperature will cause the cartridge assembly to make adjustments in the ratio of hot to cold inlet water flow, thus ensuring that the outlet water temperature remains essentially static.

In many applications, the degree of outlet temperature regulation is controlled by safety codes administered by the country where installation has taken place. This is especially true of applications in hospitals, nursing and assisted living homes or private residences where the concern of scalding the young or elderly may occur. Such safety codes outline the degree of outlet mixed water temperature as a function of desired setpoint temperature, when the inlet water temperature or pressure is varied. One such safety code used in the United States of America is known as A.S.S.E.—1016, which is administered by the American Society of Sanitary Engineering for Plumbing and Sanitary Research.

Accordingly, the most common prior art method for regulating the temperature of outlet water to plumbing fixtures is with pressure, temperature or combined balancing valves, meeting applicable safety codes.

Automatic means for regulating water temperature have been disclosed and the prior art includes a temperature controlled mixing fitting connected to hot and cold water inlet pipes, operated by an electromechanical motor module and fitted with a manual control means for operation due to a power failure. The electromechanical motor is adapted to be electrically connected to a temperature sensor for automatically controlling the flow of hot and cold water discharged through the mixing fitting U.S. Pat. No. 4,842,191.

Another prior art patent teaches the use of a motor driven mixing tap, wherein alternating amounts of hot and cold water are discharged into a common outlet. U.S. Pat. No. 4,768,705.

Another prior art patent describes the use of a shut off valve actuated by a temperature sensitive electric one-way solenoid (U.S. Pat. No. 5,090,436).

Another prior art patent describes the use of mechanically independent valve means for controlling the flow of hot and cold water to a water delivery channel. This prior art patent includes a data processing means having outputs connected to means for controlling said valve means (U.S. Pat. No. 4,420,811).

Another prior art patent teaches the use of a modular water temperature control unit comprising a temperature controlled motor and battery power supply which may be retrofit into existing manual water mixing valves (U.S. Pat. No. 5,944,255).

Prior art inventions that stop the flow of water do not address the need for continuous water flow at a preset temperature.

Systems that rely on temperature sensing elements mounted in communication with the outlet water do not teach how to prevent scalding as a result of sudden changes in inlet water pressure.

Systems that attempt to connect electronic temperature controls to mixing valves of unspecified construction simply cannot meet stringent world-wide safety standards.

Prior art inventions that use manual control means for backup during power failure are not considered commercially acceptable and offset the need for a device which is exclusively electronically operated and fail safe. Persons operating the valve that have weakened hands due to arthritis or other disability often experience pain or even total inability in attempting to rotate the valve manual operator means.

Prior art inventions such as described in U.S. Pat. No. 5,944,255 utilise a DC dry cell power supply that requires replacement from time to time. Accessing such battery compartments in a wet location such as a shower area is likely to cause corrosion and reduce reliability. Additionally, changing said dry cells is likely to be considered unacceptable commercially.

Prior art inventions such as described in U.S. Pat. No. 5,090,436 and U.S. Pat. No. 4,768,705 do not teach how the power supply circuits are constructed. If external AC mains supply connection is assumed, there is an obvious safety hazard due to electrocution. The present invention teaches the use of AC mains supply in an electrically safe manner, which is a requirement of worldwide safety standards administrators.

The present invention also allows a number of users to preset temperature and running time for their personal preference or safety. Such preset temperature and operating times are stored in a memory means of the controller for future selection.

The present invention also provides numerous safety features such as high water temperature alarm, running hour maintenance reminder to perform routine maintenance on mixing valve pressure and/or temperature cartridges. Further, an optional, external electrically operated solenoid valve may be connected to the control means and closed in the event of malfunction in the pressure or temperature balancing valve or motor drive assembly, such solenoid increasing reliability and safety.

The present invention also provides for auxiliary interface inputs and outputs allowing the valve to be connected to other related devices. This may include external water level detection means for automatic bath filling, water heater control to maintain selected bath water temperature, remote temperature probes means to display bath water temperature, or any other interface components that would be obvious to a person skilled in the art.

### SUMMARY OF THE INVENTION

According to an aspect of the present invention, there is provided an apparatus operable in a wet, electrically hazardous environment, comprising a gear motor driven pressure and/or temperature balancing valve for receiving cold and hot water supplies and providing mixed water outlet to a shower, bath, podiatry bath or other plumbing system, at a default, user defined or remote telemetry supplied water temperature setpoint provided by a controller means, the apparatus comprising:

a pressure and/or temperature balancing and mixing valve having a nominally cold water inlet, a nominally hot water inlet, at least one discharge outlet and pressure and/or temperature balancing means for blending cold and hot water inflows coupled respectively from said cold and hot water inlets so as to cause said mixing valve outlet to supply mixed water of a selected temperature;

an electric motor driven gear box coupled to the operating shaft of said mixing valve;

a user interface and display assembly comprising a switch input means to receive control instructions from the user and a status display means to display current water temperature and desired setpoint;

at least one temperature sensing probe mounted on or in said mixing valve outlet or plumbing circuit, adapted to be coupled with an interconnection means wherein current outlet water temperature from said mixing valve may be measured, wherein the interconnection means allows for connection to a controller means;

an optional electrically operated water solenoid hydraulically coupled in series to said mixing valve outlet and electrically coupled to an interconnection means, wherein the water solenoid is operable in a first state wherein significant water flow is prevented or in a second state wherein water flow through the solenoid valve is substantially undisturbed, said electrical interconnection coupled to the controller means;

a controller means for receiving the switch input user instructions and for transmitting status information to the display means, comprising an input for receiving said outlet water temperature, an output for transmitting motion control signals to said electric motor driven gear box, an optional output for controlling said electrically operated water solenoid valve to control the discharge of said water outlet and an interface means for providing bi-directional communication signals to externally connected equipment;

a power supply means, coupled to the AC mains source for supplying a low-voltage, isolated, electrically safe, direct current to the controller means;

a dry cell battery coupled to the controller means and low-voltage direct current power supply means.

According to another aspect of the invention, there is further provided a method for operating the present invention, which provides an apparatus operable in a wet, electrically hazardous environment, comprising a gear motor driven pressure and/or temperature balancing valve for receiving cold and hot water supplies and providing a mixed water outlet to a shower, bath or other plumbing system at a default, user defined or remote telemetry water temperature setpoint provided by a controller means, comprising:

a pressure and/or temperature balancing and mixing valve having a nominally cold water inlet, a nominally hot water inlet, at least one discharge outlet and pressure and/or temperature balancing means for blending cold and hot water inflows coupled respectively from said cold and hot water inlets so as to cause said mixing valve outlet to supply tempered mixed water of a selected temperature;

an electric motor driven gear box coupled to the operating shaft of said mixing valve;

a user interface and display assembly comprising a switch input means to receive control instructions from the user and a status display means to display current water temperature and desired setpoint;

at least one temperature sensing probe mounted on or in said mixing valve outlet or plumbing circuit, in thermal communication with mixed outlet water, adapted to be coupled with an interconnection means wherein current outlet water temperature from said mixing valve may be measured, wherein the interconnection means allows for connection to a controller means;

an optional electrically operated water solenoid hydraulically coupled in series to said mixing valve outlet and electrically coupled to an interconnection means, wherein the water solenoid is operable in a first state wherein significant water flow is prevented or in a second state wherein water flow through the solenoid valve is substantially undisturbed, said electrical interconnection coupled to the controller means;

a controller means for receiving the switch input user instructions and for transmitting status information to the display means, comprising an input for receiving said outlet water temperature, an output for transmitting motion control signals to said electric motor driven gear box, an optional output for controlling said electrically operated water solenoid valve to control the discharge of said water outlet and an interface means for providing bi-directional communication signals to externally connected equipment;

a power supply means, coupled to the AC mains source for supplying a low-voltage, isolated, electrically safe, direct current to the controller means;

a dry cell battery coupled to the controller means and low-voltage direct current power supply means.

the method comprising the steps of;

(a) waiting for user start command;

(b) opening optional water solenoid valve;

(c) loading user defined or default outlet water temperature setpoint;

(d) reading current water temperature from sensor

(e) adjusting valve opening to regulate outlet water temperature to equal desired setpoint temperature;

Other advantages, objects and features of the present invention will be readily apparent to those skilled in the art from a review of the detailed description of the preferred embodiment in conjunction with the accompanying drawings and claims.

### BRIEF DESCRIPTION OF THE DRAWINGS

The embodiments of the invention will now be described with reference to the accompanying drawings, in which:

FIG. 1 is one embodiment of the present invention, detailing a block diagram schematic of the controller and user display means, including an isometric, cut-away view of a typical pressure and/or temperature balancing valve with motor operated gear box and interconnection means to said controller means. Drawing includes a water temperature sensor probe in thermal communication with mixed outlet water flow. Drawing includes optional water solenoid valve in fluid connection to said pressure and/or temperature balancing valve outlet and electrical interconnection means with said controller means; and

FIG. 2 is a flow chart illustrating the operational sequence and input and output functions of the controller of the present invention.

With respect to the above drawings, similar references are used in different Figures to denote similar components.

### DETAILED DESCRIPTION OF THE INVENTION

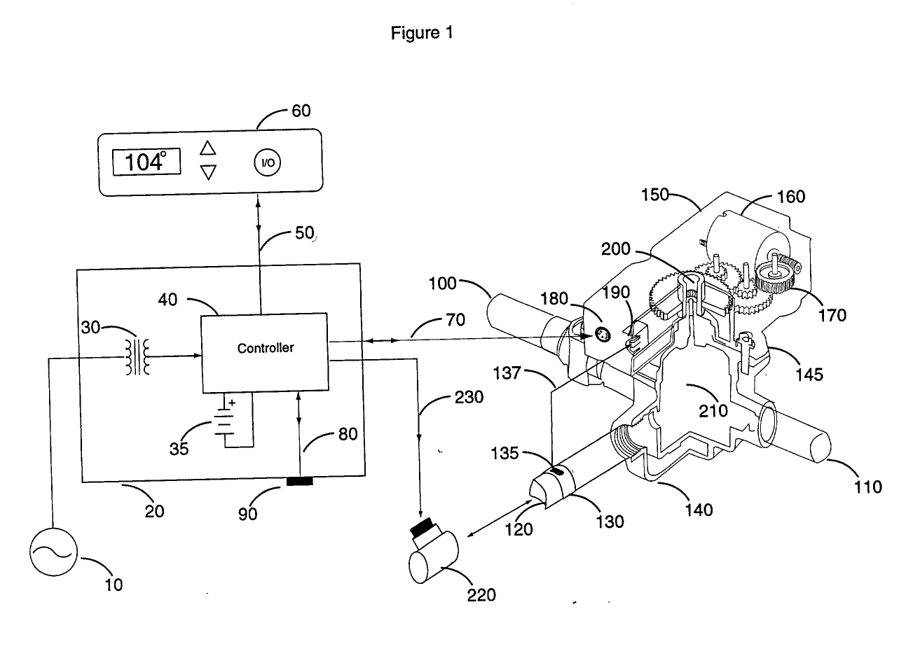

Referring to FIG. 1, there is shown an embodiment of the present invention. The present invention utilises an existing temperature and/or pressure balancing valve 140 that is capable of operating at a high speed when subjected to variations in inlet water pressure or temperature. Valve 140 contains an internal “cartridge” 210 that has been designed to rapidly adjust to momentary disturbances in the steady state pressure and/or temperature of inlet cold 100 or hot 110 water. A person skilled in the art will be aware of such valve designs. A motor driven gear box 150 is coupled to said valve 140 in such a manner as to allow an electrical control signal 70 from valve control system 20 to adjust the rotational position of the manual control operator 200 of valve 140. Rotation of manual operator 200 adjusts the “steady state” temperature of the mixed outlet water 120.

The electrical and control circuits of the present invention shall now be described with continued reference to FIG. 1. The valve control system 20 comprises a double insulation power supply 30 constructed to provide sufficient electrical and mechanical isolation between the source of a.c. mains supply 10 and the user accessible components, such as display/keypad 60. Power supply 30 is constructed so as to reduce inductive, capacitive or other leakage currents to a level to eliminate the risk of electrical shock, typically under 0.5 milliamperes of current. A person skilled in the art will be familiar with the construction of such power supplies. Power supply 30 is adapted to be coupled to a controller 40 and rechargeable drycell battery 35. In the preferred embodiment of the invention, drycell 35 is a nicad battery, nominally rated at 12 Volts and 1,000 milliampere/hours capacity.

When a.c. mains supply 10 is present, power supply 30 provides double insulated, safe, low-voltage power to controller 40, which is operably coupled to said drycell 35. Such an arrangement provides for continuous charging of drycell 35. When a.c. mains supply 10 fails for any reason, drycell 35 then provides electrical power to controller 40 to allow it to operate for period of time sufficient to ensure the closure of valve 140, by the rotation of manual valve operator 200, through motor operated gear box 150. Such an arrangement will provide for the fail-safe closure of valve 140 and the stoppage of outlet water flow 120. Alternatively, depending on the capacity of drycell 35, it may allow controller 40 to operate for extended periods of time without a.c. mains supply 10 being present.

Optional water solenoid 220, is adapted to be coupled to controller 40, through interface 230 in such a manner that upon failure of the a.c. mains supply 10, said water solenoid valve 220 will return to its normally closed position.

The arrangement of valve 140 with optional water solenoid 220 is redundant where absolute stoppage of outlet water flow 120 is required. In certain applications, valve 140 is not equipped with a stop position, such that rotation of manual operator 200 will cause steady state water temperature to vary between a minimum and maximum value. Such valves are known in the art as master mixing valves. A person skilled in the art will recognise that one or more optional water solenoid valves 220 and water temperature sensors 135 could be adapted to be coupled to controller 40 and through a manifold arrangement to a said master mixing valve. Such an arrangement would allow separate water plumbing connections to one or more appliances, thus requiring only one master mixing valve. An example of such a system would have one water solenoid valve feed a bath fill faucet, while a second water solenoid valve would supply a shower unit.

Controller 40 is adapted to be coupled to several input and output interfaces. A user keypad and display assembly 60 provides a means of status signalling and temperature display to the user. Such status signalling is communicated to controller 40 by interface 50. The user keypad and display assembly 60 may contain numerous features such as the storing of default water temperature, several user selected water temperature setpoints and water flow timers, water temperature display and diagnostic information to alert the user of failures with the apparatus of the present invention.

At least one water temperature sensor 135 is mounted in thermal communication with mixed outlet water flow 120. Said temperature sensor 135 is adapted to be coupled to controller 40 by interface 137 and 70, through convenience connections 180 and 190 mounted within motor driven gear box 150. A person skilled in the art will recognise that it is possible to mount water temperature sensor 135 in several ways, such as directly in communication with water flow or through a thermally conductive medium, such as a metallic water supply pipe 130. Such mounting of water temperature sensor 135 may be in any convenient means, provided that thermal response, will allow controller 40 to correct cold 100 and hot 110 water output 120 mixture, by rotation of manual valve operator 200 through motor driven gear box 150 with the restrictions of the appropriate said safety standards.

An optional, auxiliary interface connector 90 is provided and is adapted to be coupled to controller 40 through interface 80. Said auxiliary interface connector 90 provides a means for interconnection to optional external signalling equipment which may provide additional telemetry signals to controller 40. Such telemetry signals may include a bath water level sensor to signal to controller 40 that a bath is full and thus stop outlet water flow. Another telemetry signal includes an additional water temperature signal, adapted to be coupled to the water in a bathing vessel. Such water temperature signal may provide additional safety control by verifying thorough comparison of readings with valve water temperature sensor 135. Additionally, such bath vessel water temperature sensor may signal the need for additional hot or cold water to adjust the bath vessel water temperature.

In the preferred embodiment, motor driven gear box 150 comprises a small, high speed, direct current motor 160 adapted to be coupled to a worm gear drive assembly 170, which is in turn adapted to be coupled to manual valve operator 200. Such an arrangement of a high speed, motor 160 coupled through said gear train assembly 170 decreases motor rotational speed and increases torque at manual valve operator 200. Motor 160 is adapted to be coupled to controller 40 in a manner known to those skilled in the art through an “H” bridge drive switching device. Such as switching device allows motor 160 to be rotated in either a clockwise or counter clockwise direction by the effective reversal of d.c. voltage polarity from power supply 30 or in the event of a.c. mains 10 failure, from nicad battery 35. Reversing rotational direction of motor 160 causes a corresponding reversal of manual valve operator 200, thus adjusting the proportion of inlet cold water 100 and inlet hot water 110 within mixing cartridge 210, thus adjusting said slow speed or steady state mixed outlet water temperature.

A person skilled in the art will understand that this arrangement of adjusting said steady state water temperature and allowing said mixing cartridge 210 to adjust for high speed or momentary disturbances in inlet water pressure or temperature forms two distinct bands of operation, being the high speed or disturbance band and the set point or steady state band. Controller 40 shall operate at a predetermined speed such that adjustments of the steady state setpoint are completed at a lower rate of speed than adjustments of the disturbance band. Should controller 40 operate too quickly, this will cause internal cartridge 210 and controller 40 to interfere, thus causing instability in mixed water outlet 120 temperature.

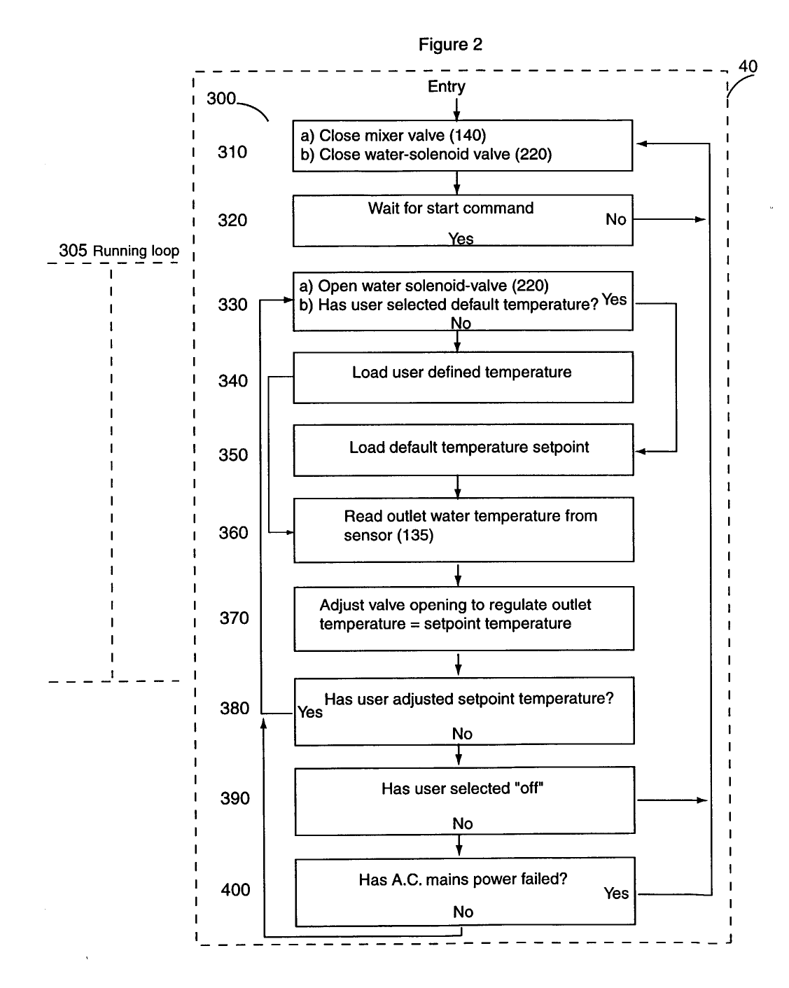

Now referring to FIG. 2, a flow chart of the operating mode sequence 300 of controller 40 is shown. When control system 20 is connected to a.c. mains supply 10, entry to operating mode sequence 300 is started. Controller 40 executes step CLOSE MIXER VALVE 310a, causing controller 40 to operate said “H” bridge to rotate motor 160 in a direction to cause manual valve operator 200 to rotate to the closed position and to execute step CLOSE WATER SOLENOID VALVE 310b, releasing water solenoid valve 220 to its normally closed condition, causing the flow of mixed outlet water 120 to stop. Controller 40 then advances to step WAIT FOR START COMMAND 320. If no start command is received, controller 40 will loop back to step CLOSE MIXER VALVE 310a, until a start command is received. When a start command is received, controller 40 advances to step OPEN WATER SOLENOID VALVE 330a, causing water solenoid valve 220 to open and to execute step HAS USER SELECTED DEFAULT TEMPERATURE? 330b. If the user has not selected a default temperature the controller 40 will advance to step LOAD USER DEFINED TEMPERATURE 340. If the user has selected to use the default temperature, the controller 40 will skip step 340 and advance to step LOAD DEFAULT TEMPERATURE SETPOINT 350. Controller 40 will upon loading the selected or default temperature setpoint advance to step READ OUTLET WATER TEMPERATURE FROM SENSOR 360 and read the water temperature data from sensor 135. Upon completion of reading the actual water temperature, controller 40 will advance to step ADJUST VALVE OPENING TO REGULATE OUTLET TEMPERATURE=SETPOINT TEMPERATURE 370, by causing controller 40 to rotate or hold still said motor 160, gear train 170 and manual gear operator 200 in the appropriate direction, to either increase, decrease or hold the desired outlet water 120 temperature, detected by said water sensor 135. A person skilled in the art will recognise that there are numerous methods that can be adapted to adjust the valve position in relation to a desired setpoint. In the preferred embodiment of the invention, a pre-calculated anticipation algorithm will be used wherein if the tolerance between actual and setpoint water temperatures are small, motor drive pulses shall be applied to cause small angular adjustment of the valve manual operator 200, with fixed inter-correction pulse time delays. If the tolerance between actual and setpoint water temperatures are great, motor drive pulses shall be applied to cause large angular adjustment of the valve motor operator 200, without undue time delays. Such an arrangement provides for rapid correction of large water to setpoint temperature tolerances, while preventing valve rotational “hunting” when actual water temperature is close to the desired setpoint temperature.

Controller 40 will advance to step HAS USER ADJUSTED SETPOINT TEMERATURE? 380. If the user has adjusted the setpoint temperature by adjusting buttons on display/keypad 60, controller 40 will advance to step HAS USER SELECTED DEFAULT TEMPERATURE 330, advancing to step LOAD USER DEFINED TEMPERATURE 340. If the user has not adjusted the setpoint temperature, the controller 40 will advance to step HAS USER SELECTED OFF 390. If the user has selected off, by pressing a button on display/keypad 60, the controller 40 will advance to step CLOSE MIXER VALVE 310a and CLOSE WATER SOLENOID VALVE 310b. If the user has not selected off, the controller 40 will advance to step HAS A.C. MAINS POWER FAILED 400. If the a.c. mains power has failed, the controller will continue to operate under power supplied by said nicad battery 35, and advance to step CLOSE MIXER VALVE 310a and CLOSE WATER SOLENOID VALVE 310b, whereupon outlet water flow 120 will stop. If the a.c. mains power has not failed, the controller 40 will advance to step OPEN WATER SOLENOID VALVE 330a, forming the running loop 305.

Numerous modifications, variations and adaptations may be made to the particular embodiments of the invention described above without departing from the scope of the invention, which is defined in the claims.

What is claimed is:

1. An apparatus safely operable in a wet environment, for controlling the outlet water temperature and flow of a pressure and/or temperature balancing valve, adapted to be coupled to a AC source for supplying an AC signal; comprising:
a motor operated gear box adapted to be coupled to the manual operator shaft of the pressure and/or temperature balancing valve wherein rotational direction of manual operator shaft is reversible by a like change in rotational direction of motor operated gear box;
a switching device coupled to the motor, the switching device being operative in either a first state wherein significant current flow through the motor is prevented or a second state wherein current flow through the motor causes rotation in a first direction or a third state wherein current flow through the motor causes rotation in a direction opposite to the first direction;
user controls for providing desired mixed outlet water temperature setpoint;
at least one water temperature sensor adapted to be coupled in thermal communication with outlet water flow;
controller means for receiving the water temperature setpoint signal from the user controls and for receiving mixed water outlet temperature from the water temperature sensor and for switching the switching device between its first, second or third states in a predetermined sequence for inducing a polarity conditioned voltage signal;
isolation means for electrically isolating the controller means from the A.C. source, wherein the isolation means includes electrical separation between the controller means and the AC source;
a dry cell battery coupled to the controller means and low voltage direct power supply means;

2. An apparatus as defined in claim 1, wherein the motor is a stepping motor.

3. An apparatus as defined in claim 1, wherein the motor is a direct current reversible motor.

4. An apparatus as defined in claim 1, wherein the switching device includes a direct current stepping motor driver.

5. An apparatus as defined in claim 1, wherein the switching device includes a bipolar stepping motor driver.

6. An apparatus as defined in claim 1, wherein the switching device includes an H bridge, direct current, motor driver.

7. An apparatus as defined in claim 1, wherein the user controls include an LED display readout.

8. An apparatus as defined in claim 1, wherein the user controls include an LCD display readout.

9. An apparatus as defined in claim 1, wherein the user controls include additional user buttons for selection of multiple water setpoint temperatures or flow time.

10. An apparatus as defined in claim 1, wherein the water temperature sensor comprises a thermistor.

11. An apparatus as defined in claim 1, wherein the water temperature sensor comprises a semiconductor temperature sensor.

12. An apparatus as defined in claim 1, where the controller means in a microcomputer device.

13. An apparatus as defined in claim 1, wherein the isolation means includes a stepdown transformer for receiving the AC signal and providing a stepped down signal to the controller means.

14. An apparatus as defined in claim 1, wherein the isolation means includes a switch mode power supply for receiving the AC signal and providing a stepped down signal to the controller means.

15. An apparatus as defined in claim 1, wherein the isolation means includes a radio telemetry signal between the user controls and the controller means.

16. An apparatus as defined in claim 1, wherein the dry cell battery means is a rechargeable battery.

17. An apparatus as defined in claim 1, wherein the dry cell battery means is a rechargeable battery.

18. An apparatus as defined in claim 1, wherein the dry cell battery means is a nickel cadmium battery.

19. An apparatus as defined in claim 1, wherein the dry cell battery means is a lithium ion battery.

20. A method for controlling the outlet water temperature and flow of a pressure and/or temperature balancing valve, adapted to be coupled to a AC source for supplying an AC signal; comprising:
a motor operated gear box adapted to be coupled to the manual operator shaft of the pressure and/or temperature balancing valve wherein rotational direction of manual operator shaft is reversible by a like change in rotational direction of motor operated gear box;
a switching device coupled to the motor, the switching device being operative in either a first state wherein significant current flow through the motor is prevented or a second state wherein current flow through the motor causes rotation in a first direction or a third state wherein current flow through the motor causes rotation in a direction opposite to the first direction;
user controls for providing desired mixed outlet water temperature setpoint;
at least one water temperature sensor adapted to be coupled in thermal communication with outlet water flow;
controller means for receiving the water temperature setpoint signal from the user controls and for receiving mixed water outlet temperature from the water temperature sensor and for switching the switching device between its first, second or third states in a predetermined sequence for inducing a polarity conditioned voltage signal;
isolation means for electrically isolating the controller means from the A.C. source, wherein the isolation means includes electrical separation between the controller means and the AC source;
a dry cell battery coupled to the controller means and low voltage direct power supply means;
the method comprising the steps of:
(a) waiting for user start command;
(b) opening optional water solenoid valve;
(c) loading user defined or default outlet water temperature setpoint;
(d) reading current water temperature from sensor;
(e) adjusting valve opening to regulate outlet water temperature to equal desired setpoint temperature.
